(19) United States
(12) Patent Application Publication
(10) Pub. No.: US 2024/0248908 A1
(43) Pub. Date: Jul. 25, 2024

(54) DATA PARSER WITH DIALECT PREDICTION

(71) Applicant: Microsoft Technology Licensing, LLC, Redmond, WA (US)

(72) Inventors: Laurent BOUÉ, Petah Tikva (IL); Kiran RAMA, Bangalore (IN)

(21) Appl. No.: 18/159,023

(22) Filed: Jan. 24, 2023

(51) Int. Cl. G06F 16/25

(52) U.S. Cl. CPC G06F 16/258

(57) ABSTRACT

A system inputs a textual sample of the structured datastore including the unknown structure properties into a trained machine learning model, wherein the trained machine learning model is trained by textual training samples of structured training datastores with labeled structure properties corresponding to the unknown structure properties and includes a loss function corresponding to each labeled structure property. The system predicts labels for the unknown structure properties of the structured datastore using the trained machine learning model based on the textual sample. The system may parse the structured datastore based on the predicted labels or output a structured datastore formatted in compliance with the predicted structure dialect.

### BACKGROUND

Data can be stored and shared in many different formats. Even specific data formats can have sub-variations. For example, CSV (comma-separated values) format is widely adopted for storing and sharing tabular data. Nevertheless, even though a standardized CSV format is recommended by RFC4180, pertaining to a Common Format and MIME Type for Comma-Separated Values (CSV) Files, compliance with this standardized format is not required and is routinely ignored by users and developers. As one example of such a sub-variation, semicolons are commonly used in France, instead of commas, as a delimiting character in CSV format. Accordingly, data that is ostensibly stored and shared in a standardized format nevertheless exhibits surprising diversity, which seemingly runs counter to the standardization efforts.

### SUMMARY

In some aspects, the techniques described herein relate to a method of predicting unknown structure properties of data content, the method including: inputting a textual sample of the data content including the unknown structure properties into a trained machine learning model, wherein the trained machine learning model is trained by textual training samples of structured training datastores with labeled structure properties corresponding to the unknown structure properties and includes a loss function corresponding to each labeled structure property; and predicting labels for the unknown structure properties of the data content using the trained machine learning model based on the textual sample.

In some aspects, the techniques described herein relate to a computing system for predicting unknown structure properties of a structured datastore, the computing system including: one or more hardware processors; a datastore sampler executable by the one or more hardware processors and configured to generate a textual sample of the structured datastore including the unknown structure properties; a trained machine learning model executable by the one or more hardware processors, trained by textual training samples of structured training datastores with labeled structure properties corresponding to the unknown structure properties, including a loss function corresponding to each labeled structure property, and configured to predict labels for the unknown structure properties of the structured datastore based on the textual sample; and a data parser executable by the one or more hardware processors and configured to parse the structured datastore based on the predicted labels.

In some aspects, the techniques described herein relate to one or more tangible processor-readable storage media embodied with instructions for executing on one or more processors and circuits of a computing device a process of predicting unknown structure properties of a structured datastore, the process including: inputting a randomly-selected textual sample of the structured datastore including the unknown structure properties into a trained machine learning model, wherein the trained machine learning model is trained by textual training samples of structured training datastores with labeled structure properties corresponding to the unknown structure properties and includes a loss function corresponding to each labeled structure property; and predicting labels for the unknown structure properties of the structured datastore using the trained machine learning model based on the randomly-selected textual sample.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

Other implementations are also described and recited herein.

### BRIEF DESCRIPTION OF THE FIGURES

FIG. 1 illustrates an example system for parsing a structured datastore using dialect prediction.

FIG. 2 illustrates details of an example system for parsing a structured datastore using dialect prediction.

FIG. 3 illustrates example operations for parsing a structured datastore using dialect prediction.

FIG. 4 illustrates example operations for generating a structured datastore using dialect prediction.

FIG. 5 illustrates an example computing device for use in parsing a structured datastore using dialect prediction.

### DETAILED DESCRIPTION

The real-world inconsistencies in standardized data formats for structured datastores, such as CSV files, create frustration in data consumers and hinder efforts toward automated machine learning. For example, data consumers expecting data in a standardized data format can, nevertheless, anticipate that any particular data may comply with one or more variations from the expected format.

In the case of CSV format, various sub-variations or CSV dialects exist. In one implementation, CSV dialects (included in the generic classification of “structure dialects”) are defined by three parameters: delimiter characters, quote characters, and escape characters. Delimiter characters separate data fields of a structured datastore, and U_{d} is the set of all possible delimiter characters. Quote characters enclose a value that contains special characters, including without limitation a delimiter, a carriage return, and a new line, and U_{q} is the set of all possible quote characters. Escape characters are used to indicate nested quotation marks, such as to indicate the use of a quote character inside of a value, and Uₑ is the set of all possible escape characters.

In practice, each of these parameters may include one or more characters. For example, in one CSV dialect, the delimiter character is a comma, but the quote character is indicated by a string of two consecutive quote characters (“ ”). The cardinality of the set Uᵢ (denoted by card(Uᵢ)), the total number of N_{dialects} of possible CSV dialects is card(U_{d})×card(U_{q})×card(Uₑ). Even with conservative estimates (e.g., card(Uᵢ)˜10), the set of possible CSV dialects is large (e.g., N_{dialects}˜1,000).

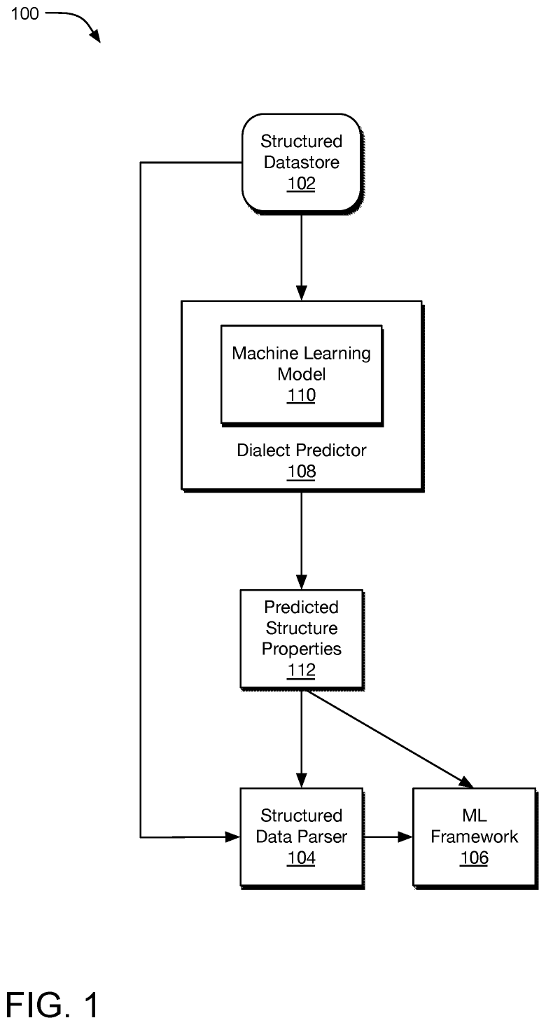

FIG. 1 illustrates an example system 100 for parsing a structured datastore 102 using dialect prediction. The structured datastore 102, such as a CSV file, is characterized by unknown structure properties, including without limitation a structure dialect, low-level data types of data fields in the structured datastore 102, and/or high-level data types of data fields in the structured datastore 102. In one implementation, a structure dialect includes without limitation one or more of the following parameters:
delimiter characters
quote characters
escape characters
   A low-level data type (also referred to as a programming language data type) represents a data type defined by the type system of the programming language that hosts a structured data parser 104 designated to parse the structured datastore 102. A high-level datatype (also referred to as a machine learning framework datatype) represents a data type defined by a machine learning framework 106 designated to process the structured datastore 102. For example, a zip code data field may be identified as an integer for its low-level data type but be identified as a “zip code,” or even a string, as its high-level data type because that is how the machine learning framework 106 will interpret values in the zip code data field.

The machine learning framework 106 can perform high-level data-type-specific processing configured for a designated processing objective, such as data analytics, weather forecasts, image processing, etc. Example machine learning frameworks may include without limitation Azure ML Studio (Microsoft), TransmogrifAI (Salesforce), AutoGluon (Amazon), and Google TensorFlow Data Validation.

One or more samples of the structured datastore 102 are input to a dialect predictor 108, which includes a machine learning model 110 trained by textual training samples of structured training datastores with labeled structure properties corresponding to the unknown structure properties. The machine learning model 110 includes a loss function corresponding to each labeled structure property. The one or more samples of the structured datastore 102 are input to the machine learning model 110, which predicts labels of the unknown structure properties corresponding to the structured datastore 102. The label predictions are output from the dialect predictor 108 as predicted structure properties 112.

Given the multiple loss functions, the problem can be treated as a multiple-object classification that predicts different classifications (e.g., structure dialect, low-level data types of data fields, and/or high-level data types of data fields). In order to share feature vectors and accelerate training/inference, the machine learning model starts by sharing a common backbone, which is then split into 3 different classification heads which define 3 different loss functions. In various implementations, one or more of the loss functions may compute cross-entropy loss. The total loss function of the model is constructed as a linear combination of these three losses. Other combinations of objectives and loss functions may also be employed. Note that not all 3 classification heads may be necessary during training depending on the intended downstream use case.

In one implementation, a training dataset for the trained machine learning model (e.g., a deep learning model) consists of a collection of structured training datastores (e.g., CSV files) along with their corresponding human-annotated labels. Each structured training datastore in the training dataset is associated with two label files with different schemas. An example of a training dataset is provided below:

In a first training dataset file, each row links a structured training datastore with the human-annotated relevant structure dialect.
Label1.txt
FileID_1, dialect
FileID_2, dialect
. . .
FileID_N, dialect

In a second training dataset file, each row encodes the low-level and high-level data type for a specific column of a structured datastore. Accordingly, each structured datastore in the training data is associated with n rows in the second dataset file, where “nc” denotes the number of columns in the structured datastore.
Label2.txt
FileID_1, columnID_1, low-level data type, high level data type
FileID_1, columnID_2, low-level data type, high level data type
. . .
FileID_1, columnID_nc1, low-level data type, high level data type
FileID_2, columnID_1, low-level data type, high level data type
FileID_2, columnID_2, low-level data type, high level data type
. . .
FileID_2, columnID_nc2, low-level data type, high level data type
. . .
FileID_N, columnID_ncN, low-level data type, high level data type

One or more of the predicted structure properties 112 are input to the structured data parser 104 to parse the structured datastore 102 for input to the machine learning framework 106. For example, the structure dialect and the low-level data types are used by the structured data parser 104 to accurately parse the structured datastore 102 for ingestion by the machine learning framework 106. The high-level data types are input to and used by the machine learning framework 106 to process the structured datastore 102.

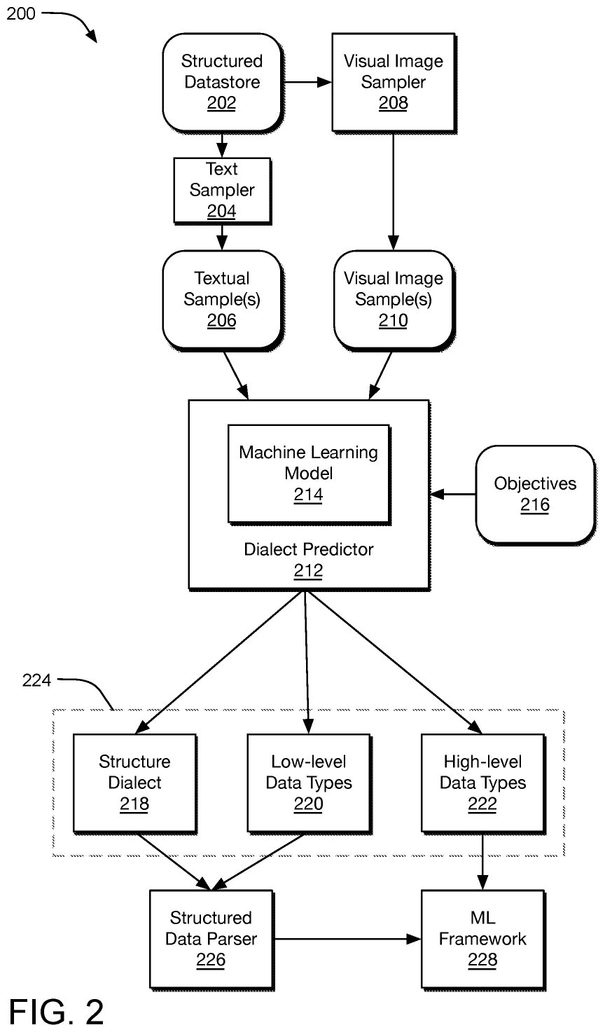

FIG. 2 illustrates details of an example system 200 for parsing a structured datastore 202 using dialect prediction. The structure properties of the structured datastore 202 are unknown to the system 200 before the structured datastore 202 is processed by the system 200.

In one implementation, the structured datastore 202 is input to a text sampler 204, which randomly samples one or more subsets of the textual data in the structured datastore 202 to generate one or more textual samples 206. In another implementation, the structured datastore 202 is input to a visual image sample 208, which randomly captures one or more visual image samples 210 of the structured datastore 202, such as by taking one or more screenshots of the structured datastore 202 when it is displayed on a display screen of a computing device. These textual and visual implementations may be employed, individually or in combination, in a prediction phase, wherein the latter approach enhances the diversity of input data used to classify the structure properties of the structured datastore 202.

The one or more textual samples 206 and/or the one or more visual image samples 210 are input to the dialect predictor 212, which includes a machine learning model 214 that is trained as described with respect to FIG. 1. The textual and visual implementations described above may be employed, individually or in combination, to train the machine learning model 214 in a training phase, wherein the latter approach enhances the diversity of training data used to train the machine learning model 214. The loss functions of the machine learning model 214 correspond to objectives 216, such as classifying a structure dialect 218 of the structured datastore 202, classifying low-level data types 220 in the structured datastore 202, and/or classifying high-level data types 222 in the structured datastore 202.

The dialect predictor 212 outputs one or more of the structure dialect 218, the low-level data types 220, and/or the high-level data types 222, collectively referred to as predicted structure properties 224. One or more of the predicted structure properties 224 are input to the structured data parser 226 to parse the structured datastore 202 for input to the machine learning framework 228. For example, the structure dialect and the low-level data types are used by the structured data parser 226 to accurately parse the structured datastore 202 for ingestion by the machine learning framework 228. The high-level data types are input to and used by the machine learning framework 228 to process the structured datastore 202.

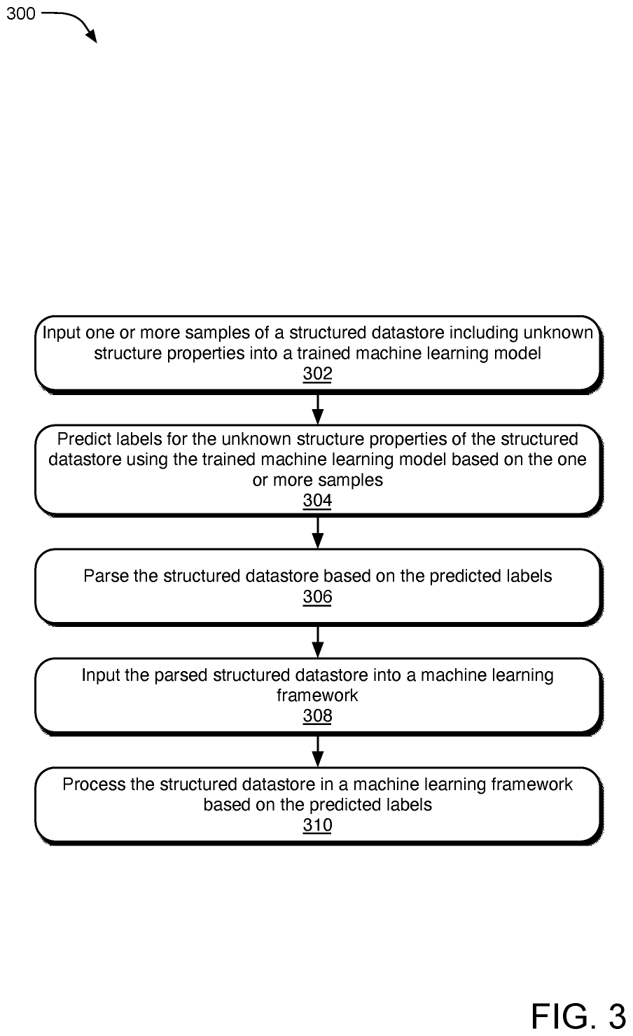

FIG. 3 illustrates example operations 300 for parsing a structured datastore using dialect prediction. An inputting operation 302 inputs one or more samples (e.g., textual samples and/or visual image samples) of a structured datastore into a trained machine learning model. The structured datastore includes one or more unknown structure properties (the structure dialect, low-level data types for data fields, and/or high-level data types of data fields, and potentially other structure properties). The trained machine learning model is trained by textual training samples of structured training datastores with labeled structure properties corresponding to the unknown structure properties and includes a loss function corresponding to each labeled structure property. In some implementations, one or more of the loss functions include a cross-entropy loss function.

A prediction operation 304 predicts labels for the unknown structure properties of the structured datastore using the trained machine learning model based on the one or more samples. Given the predicted structure properties, identified by the predicted labels), a parsing operation 306 parses the structured datastore based on one or more of the predicted structure properties. Another inputting operation 308 inputs the parsed structured datastore into a machine learning framework for processing in a processing operation 310 based on one or more of the predicted structure properties (e.g., high-level data types).

A technical benefit of the method illustrated in and described with regard to FIG. 3 is that a structured datastore having unknown structure properties may be automatically parsed according to one or more of a predicted structure dialect and low-level data types and processed within a machine learning framework according to one or more high-level data types rather than requiring manual intervention.

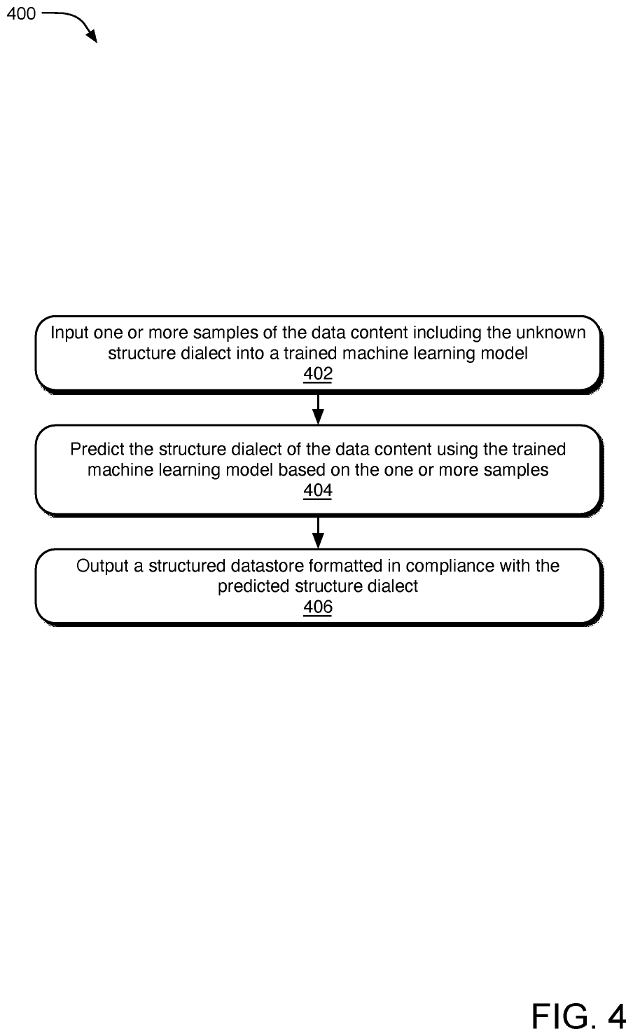

FIG. 4 illustrates example operations 400 for generating a structured datastore using dialect prediction. In this scenario, samples of data content are input to a trained machine learning model (e.g., trained as described with regard to FIGS. 1 and 2). The machine learning model then predicts an appropriate dialect for the data content and outputs a serialized version of the data content into a structured datastore having the predicted dialect. Accordingly, using samples from the data content, the trained machine learning model can be used to predict an appropriate dialect into which the data content can be serialized to assist downstream consumers by providing a consistent CSV file format instead of an inconsistent CSV file format that would require manual intervention.

An inputting operation 402 inputs one or more samples (e.g., textual samples and/or visual image samples) of the data content into a trained machine learning model. The data content includes one or more unknown structure properties (the structure dialect, low-level data types for data fields, and/or high-level data types of data fields, and potentially other structure properties). The trained machine learning model is trained by textual training samples of structured training datastores with labeled structure properties corresponding to the unknown structure properties and includes a loss function corresponding to each labeled structure property. In some implementations, one or more of the loss functions include a cross-entropy loss function.

A prediction operation 404 predicts labels for the unknown structure properties of the data content using the trained machine learning model based on the one or more samples. Typically, the prediction of the structure dialect is sufficient for the operational flow described with regard to FIG. 4. An outputting operation 406 renders the data content into a structured datastore that is compliant with the predicted structure dialect. For example, the outputting operation 406 serializes the data content, applying one or more of the following:
separating data fields using predicted delimiter character(s)
instrumenting quotes using the predicted quote character(s)
instrumenting special characters using the predicted escape character(s)

A technical benefit of the method illustrated and described with regard to FIG. 4 is that translation of data content into a structured datastore may be automatically executed using a predicted structure dialect and its parameters rather than requiring manual intervention.

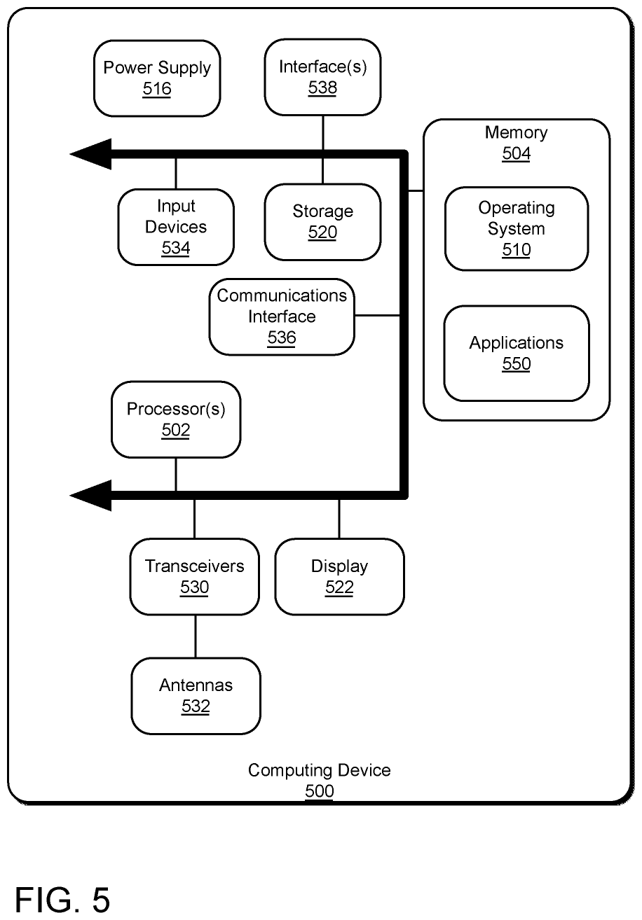

FIG. 5 illustrates an example computing device 500 for use in parsing a structured datastore using dialect prediction. The computing device 500 may be a client device, such as a laptop, mobile device, desktop, tablet, or a server/cloud device. The computing device 500 includes one or more processor(s) 502, and a memory 504. The memory 504 generally includes both volatile memory (e.g., RAM) and nonvolatile memory (e.g., flash memory). An operating system 510 resides in the memory 504 and is executed by the processor(s) 502.

In the example computing device 500, as shown in FIG. 5, one or more modules or segments, such as applications 550, a communication interface, a trained machine learning model, a dialect predictor, a structured data parser, a machine learning framework, and other program code and modules are loaded into the operating system 510 on the memory 504 and/or storage 520 and executed by processor(s) 502. The storage 520 may store data content, a structure datastore, labels, structure properties, and other data and be local to the computing device 500 or may be remote and communicatively connected to the computing device 500. In particular, in one implementation, components of a system for data parsing with dialect prediction may be implemented entirely in hardware or in a combination of hardware circuitry and software.

The computing device 500 includes a power supply 516, which is powered by one or more batteries or other power sources, and which provides power to other components of the computing device 500. The power supply 516 may also be connected to an external power source that overrides or recharges the built-in batteries or other power sources.

The computing device 500 may include one or more communication transceivers 530, which may be connected to one or more antenna(s) 532 to provide network connectivity (e.g., mobile phone network, Wi-Fi®, Bluetooth®) to one or more other servers and/or client devices (e.g., mobile devices, desktop computers, or laptop computers). The computing device 500 may further include a communications interface 536 (such as a network adapter or an I/O port, which are types of communication devices). The computing device 500 may use the adapter and any other types of communication devices for establishing connections over a wide-area network (WAN) or local-area network (LAN). It should be appreciated that the network connections shown are exemplary and that other communications devices and means for establishing a communications link between the computing device 500 and other devices may be used.

The computing device 500 may include one or more input devices 534 such that a user may enter commands and information (e.g., a keyboard or mouse). These and other input devices may be coupled to the server by one or more interfaces 538, such as a serial port interface, parallel port, or universal serial bus (USB). The computing device 500 may further include a display 522, such as a touchscreen display.

The computing device 500 may include a variety of tangible processor-readable storage media and intangible processor-readable communication signals. Tangible processor-readable storage can be embodied by any available media that can be accessed by the computing device 500 and can include both volatile and nonvolatile storage media and removable and non-removable storage media. Tangible processor-readable storage media excludes intangible communications signals (such as signals per se) and includes volatile and nonvolatile, removable and non-removable storage media implemented in any method or technology for storage of information such as processor-readable instructions, data structures, program modules, or other data. Tangible processor-readable storage media includes, but is not limited to, RAM, ROM, EEPROM, flash memory or other memory technology, CDROM, digital versatile disks (DVD) or other optical disk storage, magnetic cassettes, magnetic tape, magnetic disk storage, or other magnetic storage devices, or any other tangible medium which can be used to store the desired information and which can be accessed by the computing device 500. In contrast to tangible processor-readable storage media, intangible processor-readable communication signals may embody processor-readable instructions, data structures, program modules, or other data resident in a modulated data signal, such as a carrier wave or other signal transport mechanism. The term “modulated data signal” means a signal that has one or more of its characteristics set or changed in such a manner as to encode information in the signal. By way of example, and not limitation, intangible communication signals include signals traveling through wired media such as a wired network or direct-wired connection, and wireless media such as acoustic, RF, infrared, and other wireless media.

Clause 1. A method of predicting unknown structure properties of data content, the method comprising: inputting a textual sample of the data content including the unknown structure properties into a trained machine learning model, wherein the trained machine learning model is trained by textual training samples of structured training datastores with labeled structure properties corresponding to the unknown structure properties and includes a loss function corresponding to each labeled structure-property; and predicting labels for the unknown structure properties of the data content using the trained machine learning model based on the textual sample.

Clause 2. The method of clause 1, wherein the data content includes a structured datastore having the unknown structure properties.

Clause 3. The method of clause 1, wherein the unknown structure properties include a structure dialect of the data content.

Clause 4. The method of clause 1, wherein the unknown structure properties include a low-level data type of the data content.

Clause 5. The method of clause 1, wherein the unknown structure properties include a high-level data type of the data content associated with a machine learning framework.

Clause 6. The method of clause 1, further comprising: serializing the data content into a structured datastore having structure properties corresponding to the predicted labels.

Clause 7. The method of clause 6, further comprising: processing the structured datastore in a machine learning framework based on the predicted labels, including a high-level data type of the data content associated with the machine learning framework.

Clause 8. The method of clause 1, wherein the inputting operation includes inputting a visual image sample of the data content, the trained machine learning model is further trained by visual image training samples of the structured training datastores with the labeled structure properties corresponding to the unknown structure properties, and the predicting operation further predicts the unknown structure properties of the data content using the trained machine learning model based on the visual image sample.

Clause 9. A computing system for predicting unknown structure properties of a structured datastore, the computing system comprising: one or more hardware processors; a datastore sampler executable by the one or more hardware processors and configured to generate a textual sample of the structured datastore including the unknown structure properties; a trained machine learning model executable by the one or more hardware processors, trained by textual training samples of structured training datastores with labeled structure properties corresponding to the unknown structure properties, including a loss function corresponding to each labeled structure property, and configured to predict labels for the unknown structure properties of the structured datastore based on the textual sample; and a data parser executable by the one or more hardware processors and configured to parse the structured datastore based on the predicted labels.

Clause 10. The computing system of clause 9, wherein the unknown structure properties include a structure dialect of the structured datastore.

Clause 11. The computing system of clause 9, wherein the unknown structure properties include a low-level data type of the structured datastore.

Clause 12. The computing system of clause 9, wherein the unknown structure properties include a high-level data type of the structured datastore associated with a machine learning framework.

Clause 13. The computing system of clause 9, wherein the loss functions of all labeled structure properties are trained concurrently.

Clause 14. The computing system of clause 9, wherein the datastore sampler further configured to input a visual image sample of the structured datastore, the trained machine learning model is further trained by visual image training samples of the structured training datastores with the labeled structure properties corresponding to the unknown structure properties, and the trained machine learning model further predicts the unknown structure properties of the structured datastore using the trained machine learning model based on the visual image sample.

Clause 15. One or more tangible processor-readable storage media embodied with instructions for executing on one or more processors and circuits of a computing device a process of predicting unknown structure properties of a structured datastore, the process comprising: inputting a randomly-selected textual sample of the structured datastore including the unknown structure properties into a trained machine learning model, wherein the trained machine learning model is trained by textual training samples of structured training datastores with labeled structure properties corresponding to the unknown structure properties and includes a loss function corresponding to each labeled structure property; and predicting labels for the unknown structure properties of the structured datastore using the trained machine learning model based on the randomly-selected textual sample.

Clause 16. The one or more tangible processor-readable storage media of clause 15, wherein the unknown structure properties include a structure dialect of the structured datastore.

Clause 17. The one or more tangible processor-readable storage media of clause 15, wherein the unknown structure properties include a low-level data type of the structured datastore.

Clause 18. The one or more tangible processor-readable storage media of clause 15, wherein the unknown structure properties include a high-level data type of the structured datastore associated with a machine learning framework.

Clause 19. The one or more tangible processor-readable storage media of clause 15, further comprising: parsing the structured datastore based on the predicted labels.

Clause 20. The one or more tangible processor-readable storage media of clause 15, wherein the inputting operation includes inputting a visual image sample of the structured datastore, the trained machine learning model is further trained by visual image training samples of the structured training datastores with the labeled structure properties corresponding to the unknown structure properties, and the predicting operation further predicts the unknown structure properties of the structured datastore using the trained machine learning model based on the visual image sample.

Clause 21. A system of predicting unknown structure properties of data content, the system comprising: means for inputting a textual sample of the data content including the unknown structure properties into a trained machine learning model, wherein the trained machine learning model is trained by textual training samples of structured training datastores with labeled structure properties corresponding to the unknown structure properties and includes a loss function corresponding to each labeled structure-property; and means for predicting labels for the unknown structure properties of the data content using the trained machine learning model based on the textual sample.

Clause 22. The system of clause 21, wherein the data content includes a structured datastore having the unknown structure properties.

Clause 23. The system of clause 21, wherein the unknown structure properties include a structure dialect of the data content.

Clause 24. The system of clause 21, wherein the unknown structure properties include a low-level data type of the data content.

Clause 25. The system of clause 21, wherein the unknown structure properties include a high-level data type of the data content associated with a machine learning framework.

Clause 26. The system of clause 21, further comprising: means for serializing the data content into a structured datastore having structure properties corresponding to the predicted labels.

Clause 27. The system of clause 26, further comprising: means for processing the structured datastore in a machine learning framework based on the predicted labels, including a high-level data type of the data content associated with the machine learning framework.

Clause 28. The method of clause 21, wherein the means for inputting includes means for inputting a visual image sample of the data content, the trained machine learning model is further trained by visual image training samples of the structured training datastores with the labeled structure properties corresponding to the unknown structure properties, and the means for predicting further predicts the unknown structure properties of the data content using the trained machine learning model based on the visual image sample.

Some implementations may comprise an article of manufacture. An article of manufacture may comprise a tangible storage medium to store logic. Examples of a storage medium may include one or more types of computer-readable storage media capable of storing electronic data, including volatile memory or nonvolatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, operation segments, methods, procedures, software interfaces, application program interfaces (API), instruction sets, computing code, computer code, code segments, computer code segments, words, values, symbols, or any combination thereof. In one implementation, for example, an article of manufacture may store executable computer program instructions that, when executed by a computer, cause the computer to perform methods and/or operations in accordance with the described embodiments. The executable computer program instructions may include any suitable types of code, such as source code, compiled code, interpreted code, executable code, static code, dynamic code, and the like. The executable computer program instructions may be implemented according to a predefined computer language, manner, or syntax, for instructing a computer to perform a certain operation segment. The instructions may be implemented using any suitable high-level, low-level, object-oriented, visual, compiled, and/or interpreted programming language.

The implementations described herein are implemented as logical steps in one or more computer systems. The logical operations may be implemented (1) as a sequence of processor-implemented steps executing in one or more computer systems and (2) as interconnected machine or circuit modules within one or more computer systems. The implementation is a matter of choice, dependent on the performance requirements of the computer system being utilized. Accordingly, the logical operations making up the implementations described herein are referred to variously as operations, steps, objects, or modules. Furthermore, it should be understood that logical operations may be performed in any order, unless explicitly claimed otherwise or a specific order is inherently necessitated by the claim language.

1. A method of predicting unknown structure properties of data content, the method comprising:
inputting a textual sample of the data content including the unknown structure properties into a trained machine learning model, wherein the trained machine learning model is trained by textual training samples of structured training datastores with labeled structure properties corresponding to the unknown structure properties and includes a loss function corresponding to each labeled structure-property;
predicting labels for the unknown structure properties of the data content using the trained machine learning model based on the textual sample, wherein the labels identify known structure properties of the data content; and
extracting elements from the data content based on the known structure properties corresponding to the predicted labels, wherein the elements are accurately parseable from the data content by a machine learning framework based on the known structural properties.

2. The method of claim 1, wherein the data content includes a structured datastore having the unknown structure properties.

3. The method of claim 1, wherein the unknown structure properties include a structure dialect of the data content.

4. The method of claim 1, wherein the unknown structure properties include a low-level data type of the data content associated with a data parser of a programming language designated to parse the data content.

5. The method of claim 1, wherein the unknown structure properties include a high-level data type of the data content associated with the machine learning framework.

6. The method of claim 1, wherein extracting the elements from the data content further comprises:
serializing the data content into a structured datastore.

7. The method of claim 1,
wherein the predicted labels include a high-level data type of the data content associated with the machine learning framework.

8. The method of claim 1, wherein the inputting operation includes inputting a visual image sample of the data content, wherein the trained machine learning model is further trained by visual image training samples of the structured training datastores with the labeled structure properties corresponding to the unknown structure properties, and wherein the predicting operation further predicts the unknown structure properties of the data content using the trained machine learning model based on the visual image sample.

9. A computing system for predicting unknown structure properties of a structured datastore, the computing system comprising:
one or more hardware processors;
a datastore sampler executable by the one or more hardware processors and configured to generate a textual sample of the structured datastore including the unknown structure properties;
a trained machine learning model executable by the one or more hardware processors, trained by textual training samples of structured training datastores with labeled structure properties corresponding to the unknown structure properties, including a loss function corresponding to each labeled structure property, and configured to predict labels for the unknown structure properties of the structured datastore based on the textual sample, wherein the labels identify known structure properties of the structured datastore; and
a data parser executable by the one or more hardware processors and configured to parse the structured datastore based on the predicted labels to extract elements from the structured datastore based on the known structural properties corresponding to the predicted labels, wherein the elements are accurately parseable from the structured datastore by a machine learning framework based on the known structure properties.

10. The computing system of claim 9, wherein the unknown structure properties include a structure dialect of the structured datastore.

11. The computing system of claim 9, wherein the unknown structure properties include a low-level data type of the structured datastore associated with the data parser.

12. The computing system of claim 9, wherein the unknown structure properties include a high-level data type of the structured datastore associated with the machine learning framework.

13. The computing system of claim 9, wherein the loss functions of all labeled structure properties are trained concurrently.

14. The computing system of claim 9, wherein the datastore sampler further configured to input a visual image sample of the structured datastore, wherein the trained machine learning model is further trained by visual image training samples of the structured training datastores with the labeled structure properties corresponding to the unknown structure properties, and wherein the trained machine learning model further predicts the unknown structure properties of the structured datastore using the trained machine learning model based on the visual image sample.

15. One or more tangible processor-readable storage media embodied with instructions for executing on one or more processors and circuits of a computing device a process of predicting unknown structure properties of a structured datastore, the process comprising:
inputting a randomly-selected textual sample of the structured datastore including the unknown structure properties into a trained machine learning model, wherein the trained machine learning model is trained by textual training samples of structured training datastores with labeled structure properties corresponding to the unknown structure properties and includes a loss function corresponding to each labeled structure property, wherein the labels identify known structure properties of the structured datastore;
predicting labels for the unknown structure properties of the structured datastore using the trained machine learning model based on the randomly-selected textual sample; and
extracting elements from the structured datastore based on the known structural properties corresponding to the predicted labels, wherein the elements are accurately parseable from the structured datastore by a machine learning framework based on the known structure properties.

16. The one or more tangible processor-readable storage media of claim 15, wherein the unknown structure properties include a structure dialect of the structured datastore.

17. The one or more tangible processor-readable storage media of claim 15, wherein the unknown structure properties include a low-level data type of the structured datastore associated with a data parser of a programming language designated to parse the datastore.

18. The one or more tangible processor-readable storage media of claim 15, wherein the unknown structure properties include a high-level data type of the structured datastore associated with the machine learning framework.

19. (canceled)

20. The one or more tangible processor-readable storage media of claim 15, wherein the inputting operation includes inputting a visual image sample of the structured datastore, wherein the trained machine learning model is further trained by visual image training samples of the structured training datastores with the labeled structure properties corresponding to the unknown structure properties, and wherein the predicting operation further predicts the unknown structure properties of the structured datastore using the trained machine learning model based on the visual image sample.
